(19) United States
(12) Patent Application Publication
(10) Pub. No.: US 2018/0020280 A1
(43) Pub. Date: Jan. 18, 2018

(54) HEADPHONE SYSTEM AND METHOD

(71) Applicants: BRANDON GARCIA, STONE MOUNTAIN, GA (US); SHAMIRA GARCIA, STONE MOUNTAIN, GA (US)

(72) Inventors: BRANDON GARCIA, STONE MOUNTAIN, GA (US); SHAMIRA GARCIA, STONE MOUNTAIN, GA (US)

(21) Appl. No.: 15/649,607

(22) Filed: Jul. 13, 2017

Related U.S. Application Data
(60) Provisional application No. 62/361,990, filed on Jul. 13, 2016.

(51) Int. Cl. H04R 1/10

(52) U.S. Cl. CPC H04R 1/1041; H04R 1/105; H04R 1/1025; H04R 1/1008; H04R 2420/07; H04R 2420/09

(57) ABSTRACT

A headphone system including two audio speakers, a support band, a user interface, an audio memory storage comprising a solid-state memory drive, a power supply, two ear-pads; with each of the ear pads coupled to each of the two audio speakers; short range radio protocol structured and arranged to allow the user to input the audio files into the audio memory storage, and a universal serial bus port incorporated into the user interface structured and arranged to allow the user to input the audio files into the audio memory storage. The two audio speakers are electronically coupled to each other such that the audio sound from each audio speaker is the same or similar in volume, tone, and sound.

### CROSS-REFERENCE TO RELATED APPLICATION

The present application is related to and claims priority to U.S. Provisional Patent Application No. 62/361,990 filed Jul. 13, 2016 which is incorporated by reference herein in its entirety.

### BACKGROUND OF THE INVENTION

The following includes information that may be useful in understanding the present disclosure. It is not an admission that any of the information provided herein is prior art nor material to the presently described or claimed inventions, nor that any publication or document that is specifically or implicitly referenced is prior art.

### Technical Field

The present invention relates generally to the field of electrical audio signal processing systems and devices of existing art and more specifically relates to headphones.

### Related Art

Music can be classified as an art form and/or cultural activity whose medium is an audible sound. Music can be performed with a vast range of instruments and vocal techniques as well as pre-recorded sounds. In some instances, individuals may choose to play-back pre-recorded music by the use of portable electronic devices, or MP3 players. Also, some users may prefer to use headphones such that surrounding persons cannot hear the audible recordings being played-back to the user. In most cases, headphones include a wired or wireless connection to a memory storage device.

Generally speaking, headphones or earbuds are a pair of small loudspeaker drivers designed to be worn on or around the head and over a wearer's ears. They are generally electro-acoustic transducers, which convert an electrical signal to a corresponding sound in the wearer's ear. Headphones are designed to allow a single user to listen to an audio source privately, in contrast to a loudspeaker, which emits sound into the open air, for anyone nearby to hear. Headphones connect to a signal source such as an audio amplifier, radio, CD player, portable media player, mobile phone, video game console, or electronic musical instrument, either directly using a cord, or using wireless technology such as short range radio protocol (e.g., Bluetooth®), radio or other similar technology.

U.S. Pat. No. 7,251,335 to Jisuan Chen relates to a self contained MP3 player and earphones. The described self contained MP3 player and earphones includes a headset containing two earphones. The headset also includes an anti-noise circuit, a radio system circuit, and a sound collection circuit for providing an anti-noise capability. One of the earphones defines a cavity having an external input terminal therein. An output terminal of a conventional MP3 player is coupled to the external input terminal when the player is disposed in the cavity. The output terminal is coupled to the radio system circuit so that music played by the MP3 player can be transmitted to the earphones. A keeper is provided to retain the MP3 player in the cavity.

### SUMMARY OF THE INVENTION

In view of the foregoing disadvantages inherent in the known headphone art, the present disclosure provides a novel headphone system. The general purpose of the present disclosure, which will be described subsequently in greater detail, is to provide a novel headphone system and method of use therefore.

A headphone system is disclosed herein. The headphone system includes two audio speakers, a support band, a user interface, an audio memory storage comprising a solid-state memory drive, a power supply, two ear-pads; with each of the ear pads coupled to each of the two audio speakers; short range radio protocol structured and arranged to allow the user to input the audio files into the audio memory storage, and a universal serial bus port incorporated into the user interface structured and arranged to allow the user to input the audio files into the audio memory storage.

The two audio speakers are preferably coupled to the support band with the support band structured and arranged to be wearable upon the head of the user, and the user interface electronically coupled to at least one of said two audio speakers. Preferably, the two audio speakers are electronically coupled to each other such that the audio sound from each audio speaker is the same or similar in volume, tone, and sound. The audio memory storage is structured and arranged to allow the user to store audio files for future playback. The content stored in the memory storage includes (but is not limited to) audio speech and music.

Preferably, the power supply is removable and replaceable; and also rechargeable, and the support band is adjustable in length to accommodate multiple users. The power supply is preferably a battery or similar power supply device. The user interface preferably includes at least a volume control, an on/off/power button, a pause button, a fast-forward button, and a rewind button, in embodiments.

According to another embodiment, a method of using a headphone system is also disclosed herein. The method of use includes a first step, providing a headphone system (the headphone system including two audio speakers, a support band, a user interface, an audio memory storage, and a power supply); a second step, downloading at least one audio file to the audio memory storage; a third step, placing the headphone system upon a head of a user; a fourth step, playing the audio file upon the two audio speakers; a fifth step, ceasing playing the audio file upon the two audio speakers; a sixth step, removing the headphone system from the head of the user; and a seventh step, charging the power supply of the headphone system as needed.

For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and methods of use for the present disclosure, a headphone system, constructed and operative according to the teachings of the present disclosure.

FIG. 1 is a perspective view of the headphone system during an ‘in-use’ condition, according to an embodiment of the disclosure.

FIG. 2 is a perspective view of the headphone system of FIG. 1, according to an embodiment of the present disclosure.

FIG. 3 is an expanded view of the headphone system of FIG. 1, according to an embodiment of the present disclosure.

FIG. 4 is a perspective view of the headphone system of FIG. 1, according to an embodiment of the present disclosure.

FIG. 5 is a flow diagram illustrating a method of using a headphone system, according to an embodiment of the present disclosure.

The various embodiments of the present invention will hereinafter be described in conjunction with the appended drawings, wherein like designations denote like elements.

### DETAILED DESCRIPTION

As discussed above, embodiments of the present disclosure relate to a headphone and more particularly to a headphone system as used to improve the use of headphones by providing a headphone system which operates wirelessly with memory to store recorded audio signals within an internal memory.

Generally, the present invention and disclosure provides a user or users with a headphone system with the capabilities of playing music or other audio signals being connected (either wired or wireless) to a phone, table, MP3 player or other devices. The invention allows user(s) to download audio files directly to the system and store the files within the system. The system may include wireless connectivity to download such files, which may eliminate the need to be ‘corded’ while using the system.

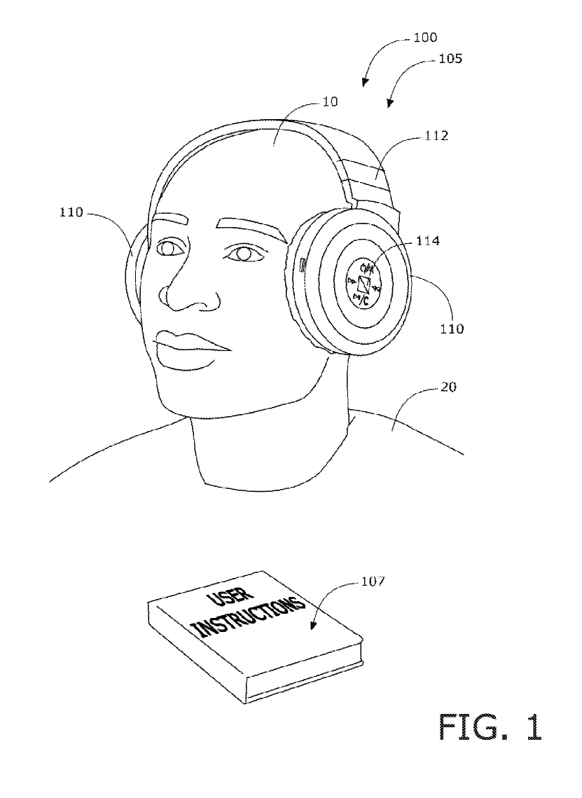

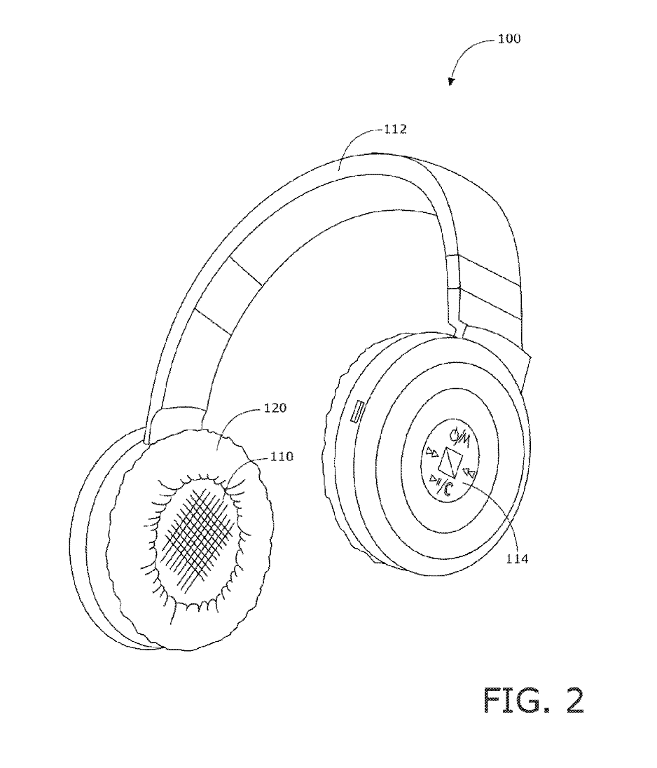

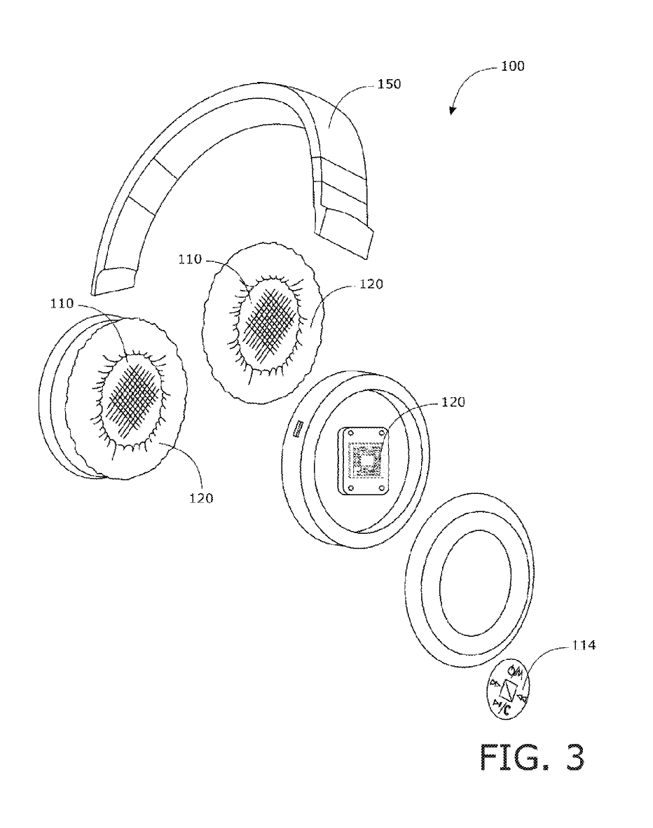

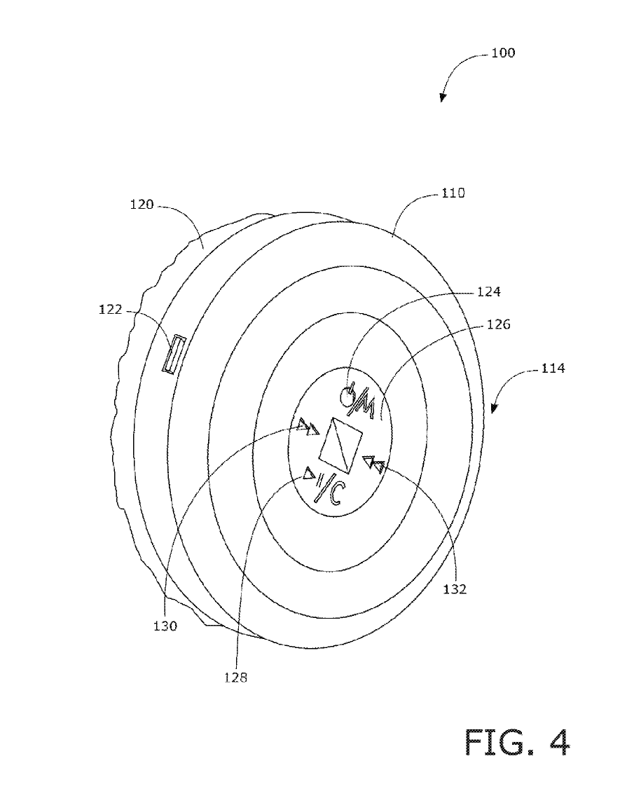

Referring now more specifically to the drawings by numerals of reference, there is shown in FIGS. 1-4, various views of a headphone system 100 during an ‘in-use’ condition 50, according to an embodiment of the present disclosure. Here, the headphone system 100 may be beneficial for use by user 20 to listen to audio signals in a wireless condition. As illustrated, headphone system 100 may include two audio speakers 110, support band 112, user interface 114, audio memory storage 116; and power supply (not shown in FIGS.). In embodiments, user interface 114 may be coupled electronically or wirelessly to at least one of two audio speakers 110 and two audio speakers 110 may be also coupled electronically or wirelessly to each other.

Audio memory storage 116 may allow user 20 to download and store audio files upon headphone system 100 for future playback. Headphone system 100 may additionally include universal serial bus port 122 (i.e., USB) to allow user 20 to input/download audio files into audio memory storage 116. Additional capabilities of headphone system 100 may include short range radio protocol for downloading/inputting files to headphone system 100, where audio memory storage 116 may include a solid-state drive. Audio files may include music, human speech or other types of audio signals or sounds.

Two audio speakers 110 may be coupled to support band 112, with support band 112 structured and arranged to be wearable upon head of user 10. Support band 112 may also be adjustable in length to accommodate for multiple users 10 of differing sizes. Ear-pads 120 may also be included, coupled to each of two audio speakers 110 for increased comfort 20 to user during use.

Power supply 118 of headphone system 100 may include internal memory storage 116, in embodiments. Embodiments may also include memory audio memory storage 116 which may be removable, and also replaceable. Embodiments may also include a rechargeable power supply.

Also, user interface 114 may include a multitude of controls. Such controls may include volume control 124, on/off (i.e. power) button 126, pause button and play button 128, fast-forward button 130, and rewind button 132. Other embodiments may include additional buttons and/or controls as needed.

According to one embodiment, the headphone system 100 may be arranged as a kit 105. In particular, the headphone system 100 may further include a set of instructions 107. The instructions 107 may detail functional relationships in relation to the structure of the headphone system 100 such that the headphone system 100 can be used, maintained, or the like, in a preferred manner.

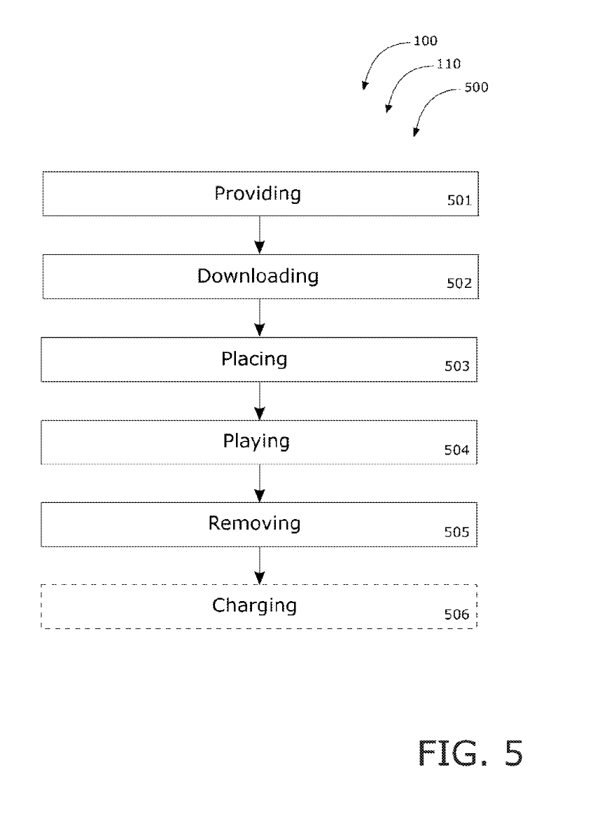

FIG. 5 is a flow diagram 550 illustrating a method of use 500 for a headphone system 100, according to an embodiment of the present disclosure. In particular, the method of use 500 for a headphone system 100 may include one or more components or features of the headphone system 100 as described above. As illustrated, the method of using a headphone system 100 may include step one 501, providing headphone system 100, headphone system 100 including two audio speakers 110, support band 112, user interface 114, audio memory storage 116, and power supply; step two 502, downloading at least one audio file to said audio memory storage; step three 503, placing headphone system 100 upon a head of a user; step four 504, playing audio file upon at least one of two audio speakers 110; step five 505, ceasing playing audio file upon two audio speakers110; step six 506, removing headphone system 100 from head 10 of user; and step seven 507, charging power supply of headphone system 100 as needed.

It should be noted that step seven 507 is an optional step and may not be implemented in all cases. Optional steps of method of use 500 are illustrated using dotted lines in FIG. 5 so as to distinguish them from the other steps of method of use 500. It should also be noted that the steps described in the method of use can be carried out in many different orders according to user preference. The use of “step of” should not be interpreted as “step for”, in the claims herein and is not intended to invoke the provisions of 35 U.S.C. §112(f). It should also be noted that, under appropriate circumstances, considering such issues as design preference, user preferences, marketing preferences, cost, structural requirements, available materials, technological advances, etc., other methods for using a headphone device are taught herein.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A headphone system, the system comprising:
two audio speakers;
a support band;
a user interface;
an audio memory storage; and
a power supply;
wherein said headphone system comprises said two audio speakers, said support band, said user interface and said audio memory storage;
wherein said two audio speakers are coupled to said support band structured and arranged to be wearable upon a head of a user;
wherein said user interface is electronically coupled to at least one of said two audio speakers;
wherein said two audio speakers are electronically coupled to each other; and
wherein said audio memory storage is structured and arranged to allow said user to store audio files for future playback.

2. The system of claim 1, further including two ear-pads, with each of said ear pads coupled to each of said two audio speakers.

3. The system of claim 1, further including a universal serial bus port incorporated into said user interface structured and arranged to allow said user to input said audio files into said audio memory storage.

4. The system of claim 1, further including a short range radio protocol structured and arranged to allow said user to input said audio files into said audio memory storage.

5. The system of claim 4, wherein said audio memory storage comprises a solid-state memory drive.

6. The system of claim 1, wherein said power supply is removable and replaceable.

7. The system of claim 1, wherein said power supply is rechargeable.

8. The system of claim 1, wherein said support band is adjustable in length to accommodate multiple said users.

9. The system of claim 1, wherein said audio files include music.

10. The system of claim 1, wherein said audio files include human speech.

11. The system of claim 1, wherein said memory storage is removable and replaceable.

12. The system of claim 1, wherein said user interface includes a volume control.

13. The system of claim 1, wherein said user interface includes an on/off button.

14. The system of claim 1, wherein said user interface includes a pause button.

15. The system of claim 1, wherein said user interface includes a fast-forward button.

16. The system of claim 1, wherein said user interface includes a rewind button.

17. A headphone system, the system comprising:
two audio speakers;
a support band;
a user interface;
an audio memory storage comprising a solid-state memory drive;
a power supply;
two ear-pads, with each of said ear pads coupled to each of said two audio speakers;
short range radio protocol structured and arranged to allow said user to input said audio files into said audio memory storage;
a universal serial bus port incorporated into said user interface structured and arranged to allow said user to input said audio files into said audio memory storage;
wherein said headphone system comprises said two audio speakers, said support band, said user interface and said audio memory storage;
wherein said two audio speakers are coupled to said support band structured and arranged to be wearable upon a head of a user;
wherein said user interface is electronically coupled to at least one of said two audio speakers;
wherein said two audio speakers are electronically coupled to each other;
wherein said audio memory storage is structured and arranged to allow said user to store audio files for future playback;
wherein said power supply is removable and replaceable;
wherein said power supply is rechargeable;
wherein said support band is adjustable in length to accommodate multiple said user;
wherein said audio files include music and human speech;
wherein said memory storage is removable and replaceable;
wherein said user interface includes a volume control;
wherein said user interface includes an on/off button;
wherein said user interface includes a pause button;
wherein said user interface includes a fast-forward button; and
wherein said user interface includes a rewind button.

18. The system of claim 17, further comprising a set of instructions; and
wherein said system is arranged as a kit.

19. A method of using a headphone system, said method comprising the steps of:
providing a headphone system, said headphone system including two audio speakers, a support band, a user interface, an audio memory storage, and a power supply;
downloading at least one audio file to said audio memory storage;
placing said headphone system upon a head of a user;
playing said audio file upon said two audio speakers;
ceasing playing said audio file upon said two audio speakers; and
removing said headphone system from said head of said user.

20. The method of claim 19, further comprising the steps of:
charging said power supply of said headphone system as needed.
